(19) United States
(12) Patent Application Publication
(10) Pub. No.: US 2026/0149867 A1
(43) Pub. Date: May 28, 2026

(54) IMAGING APPARATUS, CONTROL METHOD, AND STORAGE MEDIUM

(71) Applicant: CANON KABUSHIKI KAISHA, Tokyo (JP)

(72) Inventor: KOTOMI KAKIUCHI, Tokyo (JP)

(21) Appl. No.: 19/399,277

(22) Filed: Nov. 24, 2025

(30) Foreign Application Priority Data
Nov. 28, 2024 (JP) 2024-207381

(51) Int. Cl. H04N 23/611; G06T 7/246; G06T 7/73; H04N 23/69; H04N 23/695

(52) U.S. Cl. CPC H04N 23/611; G06T 7/246; G06T 7/73; H04N 23/69; H04N 23/695; G06T 2207/30196

(57) ABSTRACT

An imaging apparatus includes an imaging unit and a control unit, where the control unit is configured to identify a position of a subject based on an image captured by the imaging unit, detect a position of a tag, and switch, based on a change in the position of the tag, whether a position of a main subject is the identified position of the subject or the detected position of the tag.

### BACKGROUND

### Field of the Technology

The present disclosure relates to an imaging apparatus, a control method, and a storage medium.

### Description of the Related Art

There are provided apparatuses that automatically image a subject.

As a technique relating to such apparatuses, for example, Japanese Patent Laid-Open No. 2008-288745 describes a technique relating to a video information processing apparatus that captures an image based on positional information about a subject acquired using a wireless tag.

There are also techniques relating to imaging apparatuses that search for a specific subject and automatically image the subject.

Using the technique described in Japanese Patent Laid-Open No. 2008-288745 allows the imaging apparatus to detect the position and the distance of the subject holding or wearing the tag and to be directed in a direction where the imaging apparatus can image the subject by automatically panning and tilting based on this positional information.

The technique described in Japanese Patent Laid-Open No. 2008-288745 is not seen to discuss handling cases where the subject has unintentionally left behind or lost the tag. When the subject has unintentionally left behind or lost the tag, the imaging range is undesirably fixed and therefore it is desirable to capture an image while directing the imaging apparatus in the direction toward the subject instead of the tag.

### SUMMARY

The present disclosure is directed to enabling an imaging apparatus configured to automatically capture an image to realize both imaging based on a position of a tag and imaging based on a position of a subject.

According to an aspect of the present disclosure, an imaging apparatus includes an imaging unit and a control unit, where the control unit is configured to identify a position of a subject based on an image captured by the imaging unit, detect a position of a tag, and switch, based on a change in the position of the tag, whether a position of a main subject is the identified position of the subject or the detected position of the tag.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are diagrams schematically illustrating an imaging apparatus according to first and second embodiments of the present disclosure.

FIG. 2 is a diagram illustrating the configuration of a system according to the first embodiment of the present disclosure.

FIG. 3 is a block diagram illustrating the configuration of the imaging apparatus according to the first and second embodiments of the present disclosure.

FIG. 4 is a flowchart illustrating an example of an operation of the imaging apparatus according to the first and second embodiments of the present disclosure.

FIG. 5 is a flowchart illustrating an example of an operation of the imaging apparatus according to the first embodiment of the present disclosure.

FIGS. 6A and 6B are diagrams illustrating an example of an operation of the imaging apparatus according to the first and second embodiments of the present disclosure.

FIG. 7 is a diagram illustrating the configuration of a system according to the second embodiment of the present disclosure.

FIG. 8 is a diagram illustrating the configuration of a screen displayed on an information processing apparatus according to the second embodiment of the present disclosure.

FIG. 9 is a flowchart illustrating an example of an operation of the imaging apparatus according to the second embodiment of the present disclosure.

### DESCRIPTION OF THE EMBODIMENTS

Hereinafter, embodiments of the present disclosure will be described in detail by way of example with reference to the drawings. The components described in these embodiments are merely examples, and the scope of the present disclosure is not intended to be limited thereto.

### First Embodiment

In the following description, one of the embodiments of the present disclosure will be described in detail with reference to the attached drawings.

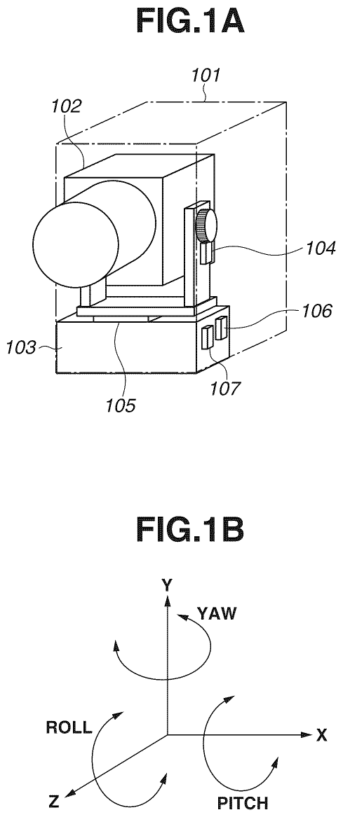

FIGS. 1A and 1B schematically illustrate an imaging apparatus according to a first embodiment.

An imaging apparatus 101 illustrated in FIG. 1A includes, for example, an operation member for operating a power switch (hereinafter referred to as a power button, although operations such as a tap, a flick, or a swipe on a touch panel may also be used). A barrel 102, which is a housing including an imaging lens unit and an image sensor for capturing an image, is attached to the imaging apparatus 101, and includes a rotational mechanism that can rotationally drive the barrel 102 relative to a fixed portion 103. A tilt rotational unit 104 is a motor driving mechanism that can rotate the barrel 102 in a pitch direction illustrated in FIG. 1B, and a pan rotational unit 105 is a motor driving mechanism that can rotate the barrel 102 in a yaw direction. Therefore, the barrel 102 is rotatable in one or more axial directions. FIG. 1B illustrates the definitions of the axes at the position of the fixed portion 103.

Both an angular velocity sensor 106 and an acceleration sensor 107 are mounted on the fixed portion 103 of the imaging apparatus 101. Vibration of the imaging apparatus 101 is detected based on the angular velocity sensor 106 and the acceleration sensor 107, and the tilt rotational unit 104 and the pan rotational unit 105 are rotationally driven based on the detected vibration angle. This configuration enables the imaging apparatus 101 to, for example, correct shaking or a tilt of the barrel 102, which is a movable unit.

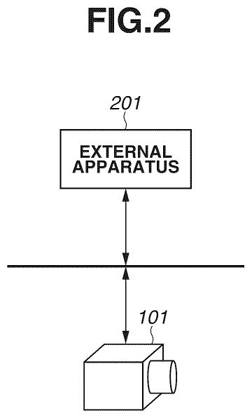

FIG. 2 is a diagram illustrating the configuration of a system according to the present embodiment. The system includes the imaging apparatus 101 and an external apparatus 201. The details of the external apparatus 201 will be described below.

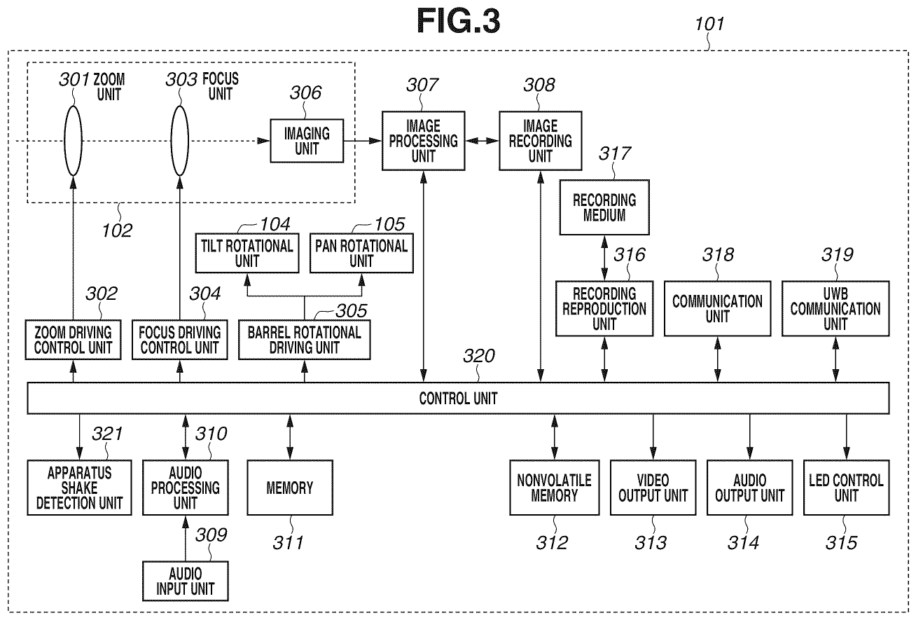

FIG. 3 is a block diagram illustrating the configuration of the imaging apparatus 101 according to the present embodiment.

In FIG. 3, a control unit 320 includes a processor (for example, a central processing unit (CPU), a graphics processing unit (GPU), a microprocessor, or a micro processing unit (MPU)), a memory (for example, a dynamic random access memory (DRAM) or a static random access memory (SRAM)), and the like. The processor and memory perform various types of processing to, for example, control each of the elements of the imaging apparatus 101 and control data transfer between the respective elements. A nonvolatile memory (electrically erasable programmable read only memory (EEPROM)) 312 is an electrically recordable and erasable memory, and stores therein a constant, a program, and the like for an operation of the control unit 320.

A zoom unit 301 includes a zoom lens for performing variable magnification. A zoom driving control unit 302 controls driving of the zoom unit 301. A focus unit 303 includes a lens for performing focus adjustment. A focus driving control unit 304 controls driving of the focus unit 303.

In an imaging unit 306, the image sensor receives light incident via each imaging lens unit, and outputs charge information corresponding to the amount of light to an image processing unit 307 as analog image data. The image processing unit 307 applies image processing such as distortion correction, white balance adjustment, and color interpolation processing to digital image data output by analog-to-digital (A/D) conversion, and outputs the processed digital image data.

The digital image data output from the image processing unit 307 is converted into a format for recording such as the Joint Photographic Experts Group (JPEG) format and the like by an image recording unit 308, and is transmitted to a memory 311 and/or a video output unit 313, which will be described below.

A barrel rotational driving unit 305 drives the tilt rotational unit 104 and the pan rotational unit 105 to drive the barrel 102 in the tilt direction and the pan direction, respectively.

An apparatus shake detection unit 321 is equipped with, for example, the angular velocity sensor (a gyroscope sensor) 106, which detects angular speeds of the imaging apparatus 101 in three axial directions, and the acceleration sensor (an accelerometer) 107, which detects accelerations of the apparatus in the three axial directions. The apparatus shake detection unit 321 calculates, for example, a rotational angle and a shift amount of the apparatus based on the detected signal.

An audio input unit 309 acquires an audio signal around the imaging apparatus 101 using a microphone provided to the imaging apparatus 101, converts analog data into digital data, and transmits the resultant data to an audio processing unit 310. The audio processing unit 310 performs audio-related processing such as processing for appropriately adjusting the input digital audio signal. Then, the audio signal processed by the audio processing unit 310 is transmitted to the memory 311 by the control unit 320. The memory 311 temporarily stores therein the image signal and the audio signal acquired by the image processing unit 307 and the audio processing unit 310, respectively.

The image processing unit 307 and the audio processing unit 310 read out the image signal and the audio signal temporarily stored in the memory 311 to, for example, encode the image signal and the audio signal, thereby generating a compressed image signal and a compressed audio signal, respectively. The control unit 320 transmits these compressed image signal and compressed audio signal to a recording reproduction unit 316.

The recording reproduction unit 316 records, for example, the compressed image signal and the compressed audio signal generated by the image processing unit 307 and the audio processing unit 310, respectively, and control data regarding imaging besides them into a recording medium 317. In a case where the audio signal is not compressively encoded, the control unit 320 transmits the audio signal generated by the audio processing unit 310 and the compressed image signal generated by the image processing unit 307 to the recording reproduction unit 316 to record them into the recording medium 317.

The recording medium 317 may be either a recording medium built in the imaging apparatus 101 or a detachable recording medium. The recording medium 317 can record various types of data such as the compressed image signal, the compressed audio signal, and the audio signal generated by the imaging apparatus 101, and, generally, a higher-capacity medium than the nonvolatile memory 312 is used as the recording medium 317. Examples of the recording medium 317 include recording media in any form, such as a hard disk, an optical disk, a magneto-optical disk, a compact disc-recordable (CD-R), a digital versatile disc-recordable (DVD-R), a magnetic tape, a nonvolatile semiconductor memory, and a flash memory.

The recording reproduction unit 316 reads out (reproduces) the compressed image signal, the compressed audio signal, the audio signal, the various types of data, and the program recorded in the recording medium 317. Then, the control unit 320 transmits the read compressed image signal and compressed audio signal to the image processing unit 307 and the audio processing unit 310, respectively.

The image processing unit 307 and the audio processing unit 310 temporarily store the compressed image signal and the compressed audio signal into the memory 311, decode them according to a predetermined procedure, and transmit the decoded signals to the video output unit 313 and an audio output unit 314, respectively.

The audio input unit 309 includes a plurality of microphones mounted on the imaging apparatus 101, and the audio processing unit 310 can detect the direction of sound on a plane where the plurality of microphones is set, and is used for a search (search processing) and automatic imaging, which will be described below. The audio processing unit 310 detects a specific audio command. The imaging apparatus 101 may be configured to enable a user to register specific audio with the imaging apparatus 101 in addition to several pre-registered commands as the audio command. The audio processing unit 310 also recognizes an audio scene. In the audio scene recognition, the audio scene is determined using a network trained through machine learning based on a large amount of audio data in advance. For example, a network for detecting a specific scene such as “people cheering”, “applauding”, or “talking” is implemented in the audio processing unit 310. The audio processing unit 310 is configured to output a detection trigger signal to the control unit 320 upon detecting the specific sound scene or the specific audio command.

The audio output unit 314 outputs a preset audio pattern from a speaker built in the imaging apparatus 101 at the time of, for example, imaging.

A light emitting diode (LED) control unit 315 controls an LED provided in the imaging apparatus 101 according to a preset lighting and blinking pattern at the time of, for example, imaging.

The video output unit 313 includes, for example, a video output terminal, and transmits image signals to display a video image on, for example, a connected external display. The audio output unit 314 and the video output unit 313 may be combined into a single terminal, such as a High-Definition Multimedia Interface (HDMI®) terminal.

A communication unit 318 performs communication between the imaging apparatus 101 and the external apparatus 201, and, for example, transmits and receives data such as an audio signal, an image signal, a compressed audio signal, and a compressed image signal. The communication unit 318 receives a control signal related to imaging, such as a command to start or end imaging, a command for pan, tilt or zoom driving and the like, and drives the imaging apparatus 101 according to an instruction from an external apparatus mutually communicable with the imaging apparatus 101. The communication unit 318 may be, for example, a wireless communication module such as an infrared communication module, a Bluetooth communication module, a wireless local area network (LAN) communication module, a wireless Universal Serial Bus (USB), or a Global Positioning System (GPS) receiver.

An Ultra Wide Band (UWB) communication unit 319 performs UWB communication between the imaging apparatus 101 and the external apparatus 201. UWB is a term referring to ultra-wide band wireless communication. The UWB communication is characterized by being able to perform highly accurate position detection by using an extremely wide frequency band. The imaging apparatus 101 communicates with the external apparatus 201 equipped with a UWB module using a UWB communication method via the UWB communication unit 319. This enables the imaging apparatus 101 to acquire positional information from the external apparatus 201. The external apparatus 201 may be, for example, a smartphone or a camera accessory equipped with a UWB module. The UWB communication between the imaging apparatus 101 and the external apparatus 201 may be either automatically started based on detection that communication using the UWB method has become possible, or started based on an instruction from the user. Examples of this instruction from the user include an operation on an operation member of the imaging apparatus 101 and an operation on an operation member provided on the external apparatus 201. Alternatively, the present embodiment may be configured in such a manner that the instruction from the user is realized by an operation on another external apparatus that detects the connection relationship between the imaging apparatus 101 and the external apparatus 201. The acquisition of the positional information via the UWB communication may be either automatically started after the UWB connection is established or started based on an instruction from the user. Examples of this instruction from the user include an operation on the imaging apparatus 101, the external apparatus 201, or another external apparatus, similarly to the UWB communication. The settings of the UWB communication are necessary to be completed between the apparatuses in advance to carry out the UWB communication between the imaging apparatus 101 and the external apparatus 201. Examples of a method for realizing these communication settings include a method that transmits necessary information by carrying out communication between the imaging apparatus 101 and the external apparatus 201. Alternatively, the communication settings may be realized by a method that transmits information via a two-dimensional bar-code or a method that the user inputs necessary information to the imaging apparatus 101 or the external apparatus 201 to perform the settings.

The imaging apparatus 101 according to the present embodiment performs automatic imaging. In the automatic imaging, the imaging apparatus 101 automatically images a subject detected through searching by driving pan, tilt and zoom based on a predetermined condition. Examples of the predetermined condition include the present zoom ratio, and a result of general object recognition or a result of face recognition in the present imaging range. Alternatively, a time elapsed since the previous imaging, an audio level, or the like may be used. The automatic imaging processing will be described below.

The imaging apparatus 101 according to the present embodiment acquires the position of a tag and the position of a subject.

To acquire the position of the tag, the control unit 320 communicates with the external apparatus 201 equipped with the UWB module using the UWB communication method via the UWB communication unit 319, as already described above. This enables the imaging apparatus 101 to acquire the positional information from the external apparatus 201.

To acquire the position of the subject, first, the image processing unit 307 processes the signal captured by the imaging unit 306 to generate a subject recognition image. Next, the control unit 320 compares this subject recognition image with a predetermined pattern for determining a human face to detect a face region of a person. The control unit 320 calculates the position of the subject based on the size and the position of the face region image in the subject recognition image. This enables the imaging apparatus 101 to acquire the position of the subject.

The control unit 320 handles either the acquired position of the tag or the acquired position of the subject as the position of a main subject. The control unit 320 performs automatic imaging while changing the imaging method so as to direct the optical axis of the imaging apparatus 101 toward the main subject by rotating the barrel 102. Hereinafter, the process of changing the imaging method each time so as to direct the optical axis of the imaging apparatus 101 toward the main subject by rotating the barrel 102 will be referred to as tracking.

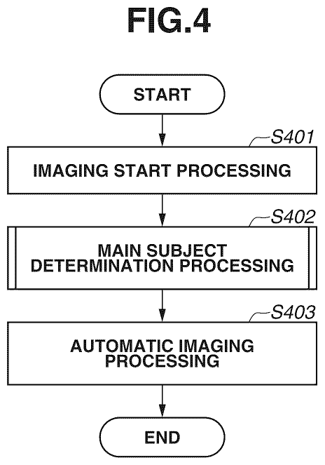

A flow of the whole processing performed by the imaging apparatus 101 according to the present embodiment will be described with reference to FIG. 4.

The control unit 320 performs imaging start processing in step S401, main subject determination processing in step S402, and automatic imaging processing in step S403. The control unit 320 starts the entire processing flow including these processes based on a predetermined condition. Examples of the predetermined condition include turning on the power of the imaging apparatus 101 by pressing the power button provided on the imaging apparatus 101. The control unit 320 repeats the entire processing flow including these processes at predetermined time intervals.

In step S401, the control unit 320 performs the imaging start processing. In this processing, the control unit 320 performs exposure control in such a manner that the subject recognition image has an appropriate brightness. The focus driving control unit 304 performs autofocus control. After the control unit 320 performs the above-described processing flow, the processing proceeds to step S402.

In step S402, the control unit 320 performs the main subject determination processing. In this processing, the control unit 320 determines which of the position of the tag and the position of the subject is to be treated as the position of the main subject, which serves as a tracking target and an imaging target. The present processing will be described below.

In step S403, the control unit 320 performs the automatic imaging processing. In this processing, the control unit 320 performs automatic imaging while tracking the main subject determined to be the tracking target and the imaging target in the main subject determination processing of step S402.

In the tracking, the composition is adjusted to keep capturing the main subject. The composition is adjusted by calculating pan, tilt, and zoom amounts based on, for example, the position and the size of the main subject in the subject recognition image, and driving the barrel rotational driving unit 305 and the zoom unit 301 provided in the imaging apparatus 101.

In the automatic imaging, the main subject is automatically imaged based on the predetermined condition, as already described above.

Examples of the predetermined condition include the present zoom ratio, and a result of general object recognition or a result of face recognition in the present imaging range. Alternatively, a time elapsed since the previous imaging, an audio level, or the like may be used.

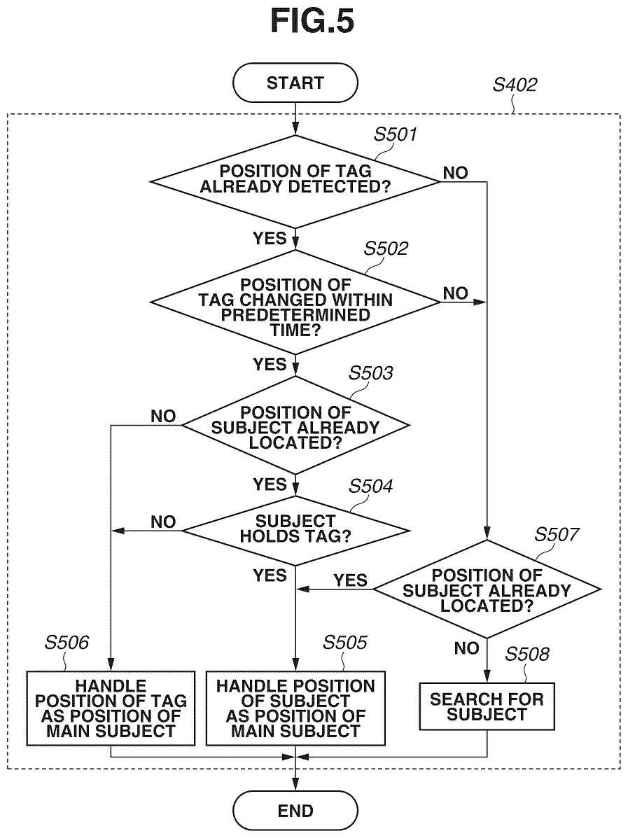

The details of the main subject determination processing of step S402 performed by the imaging apparatus 101 according to the present embodiment will be described with reference to FIG. 5.

In this processing, the control unit 320 determines which of the position of the tag or the position of the subject is to be treated as the position of the main subject, which serves as the tracking target and the imaging target.

First, in step S501, the control unit 320 determines whether the position of the tag has been already detected. At this time, the control unit 320 detects the position of the tag using the UWB method via the UWB communication unit 319. If the position of the tag has been already detected (YES in step S501), the processing proceeds to step S502.

On the other hand, if the position of the tag has not been detected yet (NO in step S501), the processing proceeds to step S507.

Next, in step S502, the control unit 320 determines whether the position of the tag has changed within a predetermined time Ta. This predetermined time Ta is a fixed time set in advance, and is stored in the nonvolatile memory 312. The predetermined time Ta is a time set as an elapsed time necessary for the control unit 320 to determine that the position of the tag has not changed, and is, for example, 10 seconds. The control unit 320 measures an elapsed time Tb since the tag positional information has stopped changing. In step S502, the control unit 320 compares the predetermined time Ta and the elapsed time Tb. Then, if the elapsed time Tb is shorter than the predetermined time Ta, i.e., if the position of the tag has changed within the predetermined time Ta (YES in step S502), the processing proceeds to step S503. On the other hand, if the elapsed time Tb is longer than the predetermined time Ta, i.e., if the position of the tag has not changed within the predetermined time Ta (NO in step S502), the processing proceeds to step S507.

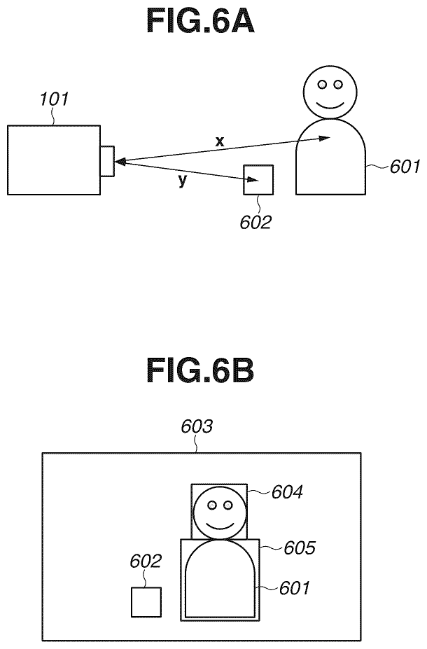

Next, in steps S503 and S504, the control unit 320 determines whether the position of the subject has been already located and whether the subject holds the tag. These determination processing procedures will be described with reference to FIGS. 6A and 6B. FIG. 6A illustrates the actual positional relationship between the imaging apparatus 101, and the subject 601 and the tag 602. FIG. 6B is a diagram illustrating a subject recognition image 603 generated by the imaging apparatus 101. FIG. 6B illustrates a face region 604 and a body region 605 of the subject 601 in the subject recognition image 603.

In step S503, the control unit 320 determines whether the position of the subject has been already located. The position of the subject refers to the direction and the distance from the imaging apparatus 101 to the central coordinate of the subject 601, and corresponds to “x” illustrated in FIG. 6A. The control unit 320 performs the following control to locate the position of the subject. First, the control unit 320 detects the face region 604 and the body region 605 in the subject recognition image 603 illustrated in FIG. 6B. Next, the control unit 320 calculates and locates the position of the subject based on the detected face region 604 and body region 605, the rotational angle of the pan and tilt when the subject recognition image 603 is captured, the zoom ratio at the same time point, and the face size and the human body size of the subject. The face size of the subject referred to herein is a value predetermined based on an average or a median of a size from the top of the head to the tip of the chin of a standard person, and is desirably, for example, approximately 23 centimeters (cm) in height and approximately 16 cm in width. The actual body size is a value predetermined based on an average or a median of a size from the base of the neck to the tips of the feet of a standard person, and is desirably, for example, approximately 142 cm in height and approximately 40 cm in width. In this case, the actual face size and body size vary depending on the person who is the subject, and therefore a slight error occurs; however, the approximate position of the subject can be located. The position of the subject may be located by calculating a facial feature amount of the subject from the subject recognition image 603 and estimating the gender from the calculated facial feature value, and using a standard face size and a human body size predetermined for each gender. This makes it possible to locate the position of the subject with higher accuracy.

If the position of the subject has been already located from this control (YES in step S503), the processing proceeds to step S504. On the other hand, if the position of the subject has not been located yet (NO in step S503), the processing proceeds to step S506. In step S506, the control unit 320 handles the position of the tag as the main subject, determining that the subject does not hold the tag.

In step S504, the control unit 320 determines whether the subject holds the tag. At this time, the imaging apparatus 101 detects the position of the tag using the UWB method via the UWB communication unit 319 again. The position of the tag refers to the direction and the distance received from the tag via the UWB communication, and corresponds to “y” illustrated in FIG. 6A. The control unit 320 compares the detected position of the tag and the position of the subject located in step S503, and determines that the subject holds the tag if the distance is a predetermined threshold value or shorter. On the other hand, if the distance between the position of the tag and the position of the subject is longer than the predetermined threshold value, the control unit 320 determines that the subject does not hold the tag.

By the above-described processing flow, the control unit 320 determines whether the subject holds the tag. The method for determining whether the subject holds the tag may be a method for determining it based on similarity between the respective motion vectors of the subject and the tag. In this case, the control unit 320 repeats steps S503 and S504 a plurality of times, thereby acquiring the position of the subject and the position of the tag a plurality of times. Then, the control unit 320 calculates the respective motion vectors of the position of the subject and the position of the tag (for example, a motion vector and/or a change amount in a predetermined period) when determining whether the subject holds the tag in step S504. Then, the control unit 320 calculates the similarity between these motion vectors based on the respective directions and sizes. The control unit 320 compares the thus-acquired similarity between the motion vectors with a predetermined threshold value, and determines whether the subject holds the tag.

If determining that the subject holds the tag in step S504 (YES in step S504), the processing proceeds to step S505. In step S505, the control unit 320 handles the position of the subject as the position of the main subject. If determining that the subject does not hold the tag (NO in step S504), the processing proceeds to step S506. In step S506, the control unit 320 handles the position of the tag as the position of the main subject.

Next, in step S507, the control unit 320 determines whether the position of the subject has been already located. The processing performed in this step is similar to the processing described in step S503. If the position of the subject is already located (YES in step S507), the processing proceeds to step S505. In step S505, the control unit 320 handles the position of the subject as the position of the main subject. The processing performed in a case where the position of the subject is not located yet will be described below.

In the above-described manner, the control unit 320 determines whether to handle the position of the subject as the position of the main subject (step S505) or handle the position of the tag as the position of the main subject (step S506) based on the condition. This enables the imaging apparatus 101 to realize both the imaging based on the position of the tag and the imaging based on the position of the subject.

If the position of the subject has not been located yet in step S507 (NO in step S507), i.e., the position of the tag has not been detected yet and the position of the subject has not been located yet, the processing proceeds to step S508. In step S508, the control unit 320 starts the processing for searching for the subject. In the subject search processing in step S508, the control unit 320 performs the following control.

First, the control unit 320 divides the entire surroundings into areas with the position of the imaging apparatus 101 as the center.

Next, the control unit 320 calculates, for each of the divided areas, an importance level indicating a priority order for search according to the subject present in the area or the scene conditions of the area. The importance level based on the state of the subject is calculated based on, for example, the number of subjects present in the area, the size of the face, the orientation of the face, and/or the likelihood of face detection. On the other hand, the importance level according to the scene conditions is, for example, a result of general object recognition, a result of scene determination (blue sky, backlight, sunset, or the like), a level of sound coming from the direction of the area, a result of audio recognition, and/or information about detection of a motion in the area.

Next, the control unit 320 determines an area whose calculated importance level is high as a search target area. Then, the control unit 320 calculates a pan and tilt search target angle necessary to capture the search target area within the imaging range.

Next, the control unit 320 calculates a pan and tilt driving amount based on the calculated pan and tilt search target angle, and performs pan and tilt driving. If the subject is present in the search target area, the control unit 320 calculates a zoom driving amount based on the size of the subject in the subject recognition image 603, and performs zoom driving.

The subject can be searched for according to the above-described processing flow.

The method for searching for the subject by performing pan and tilt driving and/or performing zoom driving has been described, but the subject may be searched for by an imaging system that images all directions at once using a plurality of wide-angle lenses.

According to the above-described processing flow, the imaging apparatus configured to perform automatic imaging according to the present embodiment can realize both the imaging based on the position of the tag and the imaging based on the position of the subject.

The subject may be an animal without being limited to a person.

### Second Embodiment

The present embodiment will be described regarding a method for enabling the user to specify a time until the tracking is switched from the tag tracking to the subject tracking.

The first embodiment has been described citing the processing in step S502 for determining whether the position of the tag has changed within the predetermined time Ta set in advance. However, an appropriate value for the predetermined time Ta from when the position of the tag stops changing until the tracking is switched to the subject tracking varies depending on the user's intended use.

The second embodiment has been contrived under such circumstances, and will be described regarding a system that enables the user to specify the time until the tracking is switched from the tag tracking to the subject tracking.

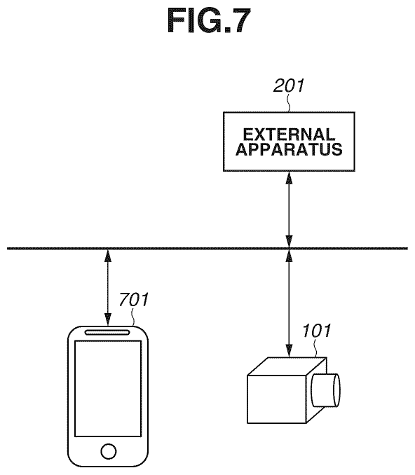

The configuration of the system that enables the user to specify the time (hereinafter referred to as a set time Tc) from when the position of the tag stops changing until the tag tracking is stopped and switched to the subject tracking will be described with reference to FIG. 7.

The system according to the present embodiment includes the imaging apparatus 101, the external apparatus 201, and an information processing apparatus 701. The imaging apparatus 101 and the external apparatus 201 are similar to those described in the first embodiment, and therefore the detailed descriptions thereof will be omitted here.

The information processing apparatus 701 is a device for communicating with and controlling the imaging apparatus 101. The information processing apparatus 701 may be, for example, a computer, a tablet terminal, or a smartphone. The present embodiment will be described citing a smartphone as an example. The functions provided by the information processing apparatus 701 according to the present embodiment are realized in the form of an application that operates on the information processing apparatus 701. The information processing apparatus 701 receives an input of the set time Tc from the user and transmits the input set time Tc to the communication unit 318. The control unit 320 performs processing for determining whether the position of the tag has changed based on the set time Tc received by the communication unit 318. This determination processing will be described below.

The external apparatus 201 may be a UWB module mounted on the information processing apparatus 701.

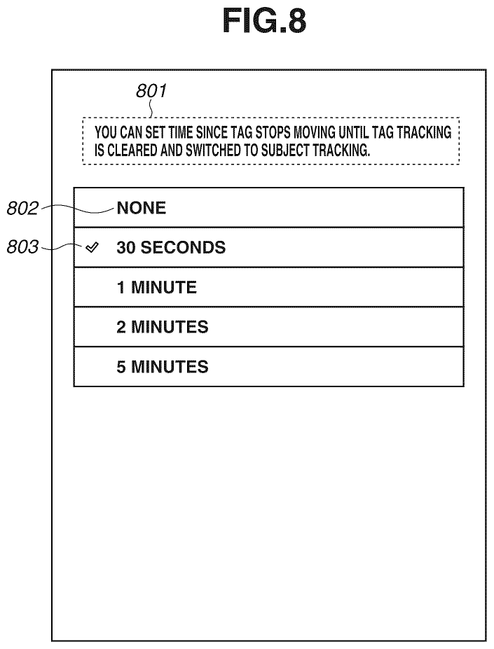

A screen for inputting the set time Tc, which is displayed on a display of the information processing apparatus 701 according to the present embodiment, will be described with reference to FIG. 8.

The screen includes a description display text 801. This text 801 indicates the content settable by pressing a setting item 802, which will be described below.

The setting item 802 is a user interface for inputting the set time Tc. A plurality of setting items 802 is prepared, and the setting can be changed by the user pressing an item. For example, the user presses “30 seconds”, the imaging apparatus 101 can be set to switch to the subject tracking 30 seconds after the position of the tag stops changing. On the other hand, when “none” is pressed, the tag tracking continues without being switched to the subject tracking even when the position of the tag has not changed. FIG. 8 illustrates that “30 seconds”, “1 minute”, “2 minutes”, and “5 minutes” are prepared as the setting items by way of example, but the setting items are not limited thereto.

A mark 803 indicates the selected setting item. In this case, the setting time Tc is “30 seconds”.

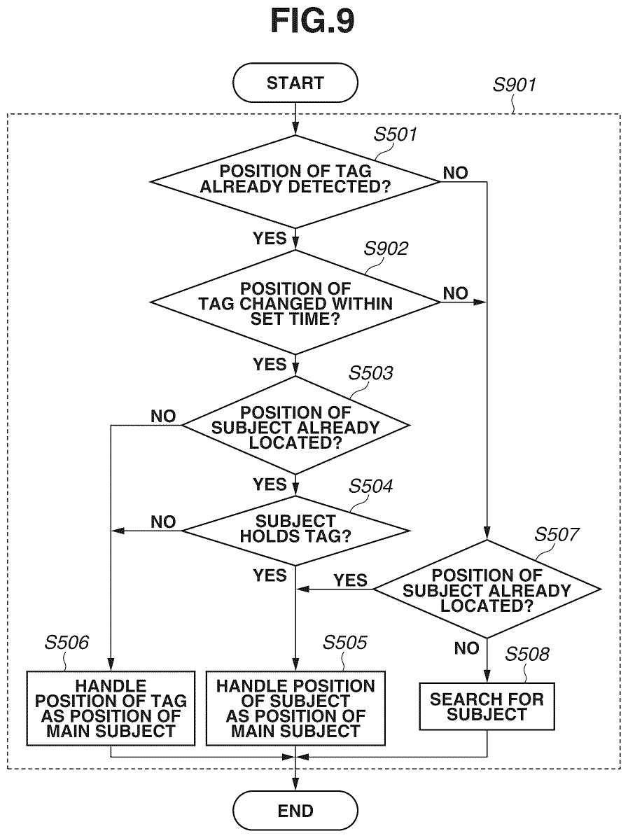

The processing performed by the imaging apparatus 101 according to the present embodiment will be described with reference to FIG. 9.

In the present embodiment, in step S902, the control unit 320 performs the processing for determining whether the position of the tag has changed based on the set time Tc input by the user. If the set time input by the user is, for example, “30 seconds”, in step S902, the control unit 320 determines whether the position of the tag has changed within 30 seconds. If the set time input by the user is “none”, in step S902, the processing proceeds to step S503 regardless of whether the position of the tag has changed.

Other than that, the processing performed by the control unit 320 in each step is similar to the processing described in the first embodiment, and therefore the detailed description thereof will be omitted here.

According to the above-described processing flow, the imaging apparatus configured to perform automatic imaging according to the present embodiment enables the user to specify the time after the position of the tag stops changing until the tag tracking is stopped and switched to the subject tracking.

The present embodiment has been described citing the method that enables the user to specify the time until the tracking is switched from the tag tracking to the subject tracking; however, the methods for accommodating different user purposes are not limited thereto.

For example, one usable method is to provide a toggle button in the application that operates on the information processing apparatus 701, and switch the imaging apparatus 101 to one of a “tag left-behind detection mode” and a “tag stationary imaging mode” each time this toggle button is pressed.

In this case, for example, in the “tag left-behind detection mode”, the control unit 320 determines that the tag has been left behind if the position of the tag does not change within the predetermined time, and switches the tracking from the tag tracking to the subject tracking. On the other hand, in the “tag stationary imaging mode”, the control unit 320 determines that the user has intentionally placed the tag even if the position of the tag does not change within the predetermined time, and continues the tag tracking.

The function of enabling the user to specify the set time Tc, which is provided by the information processing apparatus 701 according to the present embodiment, may be implemented in a form different from the application in the smartphone. For example, the present embodiment may be configured in such a manner that the imaging apparatus 101 includes an input unit for receiving an input of the set time Tc, and performs the processing in step S902 based on the set time Tc input by the user using this input unit. Alternatively, the present embodiment may be configured in such a manner that the set time Tc is stored in a server in a computer network in advance, and the imaging apparatus 101 performs the processing in step S902 based on the set time Tc received via the communication unit 318.

Having described the present disclosure in detail based on embodiments thereof, the present disclosure is not limited to these specific embodiments, and also covers various embodiments within a range that does not depart from the spirit of the present disclosure. The above-described embodiments may be partially combined as necessary.

The present disclosure also covers a case where a software program for implementing the functions of the above-described embodiments is supplied to a system or an apparatus including a computer capable of executing the program directly from a recording medium or using wired or wireless communication, and the program is executed.

Therefore, the program code itself, which is supplied to or installed in a computer to implement the functional processing of the present disclosure by the computer, also constitutes the present disclosure. In other words, the present disclosure also covers the computer program itself for implementing the functional processing of the present disclosure.

In this case, the program may be in any type of format, such as an object code, a program executed by an interpreter, or script data supplied to an operating system (OS), as long as it has a function as a program.

The recording medium for supplying the program may be, for example, a hard disk, a magnetic recording medium such as a magnetic tape, an optical or magneto-optical storage medium, or a nonvolatile semiconductor memory.

Possible examples of the method for supplying the program also include a method that the computer program constituting the present disclosure is stored in a server in a computer network, and a client computer connected thereto downloads the computer program for installation.

### Other Embodiments

The present disclosure can also be implemented by performing the following processing. That is, the present disclosure can also be realized by processing that supplies software (a program) for implementing the functions of the above-described embodiments to a system or an apparatus via a network or various kinds of storage media, and causes a computer (or a control unit, an MPU, or the like) of this system or apparatus to read out and execute the program code. In this case, this program, and the storage medium storing this program constitute the present disclosure.

Having described the present disclosure in detail based on embodiments thereof, the present disclosure is not limited to these specific embodiments, and also covers various embodiments within a range that does not depart from the spirit of the present disclosure. The above-described embodiments may be partially combined as necessary.

Each functional unit of each of the above-described embodiments (each modification) may be implemented as separate hardware. The functions of two or more functional units may be implemented by common hardware. Each of a plurality of functions of one functional unit may be implemented by separate hardware. Two or more functions of one functional unit may be implemented by common hardware. Each functional unit may be implemented by hardware such as an application specific integrated circuit (ASIC), a field-programmable gate array (FPGA), or a digital signal processor (DSP). For example, the apparatus may include a processor and a memory (a storage medium) storing a control program therein. A function of at least a part of functional units included in the apparatus may be implemented by the processor reading out the control program from the memory and executing it.

The present disclosure can also be implemented by supplying a program that realizes one or more functions of the above-described embodiments to a system or apparatus via a network or a storage medium, and causing one or more processors of a computer in the system or apparatus to read and execute the program. The present disclosure can also be implemented by a circuit (for example, an ASIC) that realizes one or more of the functions.

### Configuration 1

An imaging apparatus includes:
an imaging unit; and
a control unit configured to:
identify a position of a subject based on an image captured by the imaging unit;
detect a position of a tag; and
switch, based on a change in the position of the tag acquired by the detection unit, whether a position of a main subject is the position of the identified subject or the detected position of the tag.

### Configuration 2

The imaging apparatus as set forth in Configuration 1, wherein the control unit is further configured to determine whether the position of the tag has changed within a predetermined time.

### Configuration 3

The imaging apparatus as set forth in Configuration 1, wherein the control unit is further configured to determine whether the subject is holding the tag.

### Configuration 4

The imaging apparatus as set forth in Configuration 3, wherein the control unit is further configured to set the position of the subject as the position of the main subject in a case where it is determined that the subject is holding the tag.

### Configuration 5

The imaging apparatus as set forth in Configuration 4, wherein the control unit is further configured to set the position of the tag as the position of the main subject in a case where it is determined that the subject is not holding the tag.

### Configuration 6

The imaging apparatus as set forth in Configuration 2, wherein the control unit is further configured to set the position of the subject as the position of the main subject in a case where it is determined that the position of the tag has not changed and the position of the subject has been identified.

### Configuration 7

The imaging apparatus as set forth in Configuration 2, wherein the control unit is configured to perform processing for searching for the subject in a case where it is determined that the position of the tag has not changed and the position of the subject has not been identified.

### Configuration 8

The imaging apparatus as set forth in Configuration 1, wherein the control unit is further configured to set the position of the subject as the position of the main subject in a case where the position of the tag has not been detected and the position of the subject has been identified.

### Configuration 9

The imaging apparatus as set forth in Configuration 1, wherein the control unit is further configured to perform processing for searching for the subject in a case where the position of the tag has not been detected and the position of the subject has not been identified.

### Configuration 10

The imaging apparatus as set forth in Configuration 3, further includes:
a rotational mechanism configured to rotationally drive a housing including an imaging lens and an image sensor in at least one or more axial directions; and
a zoom mechanism configured to perform zoom driving,
wherein the control unit is further configured to determine whether the subject is holding the tag based on a rotational angle of the rotational mechanism, a zoom magnification of the zoom mechanism, the position of the tag acquired by the detection unit, and the position of the acquired subject.

### Configuration 11

The imaging apparatus as set forth in Configuration 3, wherein the control unit is further configured to:
calculate a motion vector of the position of the subject in a predetermined period, and
determine whether the subject is holding the tag based on a change amount of the position of the tag and the motion vector.

### Configuration 12

The imaging apparatus as set forth in Configuration 1, wherein the control unit is further to track the main subject by rotationally driving the rotational mechanism.

### Configuration 13

The imaging apparatus as set forth in Configuration 12, wherein the control unit is further configured to cause the imaging unit to operate based on tracking of the subject.

### Configuration 14

The imaging apparatus as set forth in Configuration 2, wherein the control unit is further configured to acquire information regarding a time specified by a user and determine whether the position of the acquired tag has changed within the predetermined time based on the information regarding the time.

### Configuration 15

The imaging apparatus as set forth in any one of Configurations 1 to 14, wherein the subject is at least one of a person or an animal.

### Method

A method for controlling an imaging apparatus including an imaging unit includes:
identifying a position of a subject based on an image captured by the imaging unit;
detecting a position of a tag; and
switching, based on a change in the acquired position of the tag, whether a position of a main subject is the position of the subject or the position of the tag.

### Computer-Readable Storage Medium

A computer-readable storage medium storing a program for causing a computer to implement:
an imaging function;
an identification function for identifying a position of a subject based on an image captured by the imaging function;
a detection function for detecting a position of a tag; and
a control function for switching, based on a change in the position of the tag acquired by the detection function, whether a position of a main subject is the position of the subject identified by the identification function or the position of the tag detected by the detection function.

An imaging apparatus configured to perform automatic imaging can realize both imaging based on a position of a tag and imaging based on a position of a subject.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-207381, filed Nov. 28, 2024, which is hereby incorporated by reference herein in its entirety.

What is claimed is:

1. An imaging apparatus comprising:
an imaging unit; and
a control unit configured to:
identify a position of a subject based on an image captured by the imaging unit;
detect a position of a tag; and
switch, based on a change in the position of the tag, whether a position of a main subject is the identified position of the subject or the detected position of the tag.

2. The imaging apparatus according to claim 1, wherein the control unit is further configured to determine whether the position of the tag has changed within a predetermined time.

3. The imaging apparatus according to claim 2, wherein the control unit is further configured to set the position of the subject as the position of the main subject in a case where it is determined that the position of the tag has not changed and the position of the subject has been identified.

4. The imaging apparatus according to claim 2, wherein the control unit is further configured to perform processing for searching for the subject in a case where it is determined that the position of the tag has not changed and the position of the subject has not been identified.

5. The imaging apparatus according to claim 2, wherein the control unit is further configured to acquire information regarding a time specified by a user and determine whether the position of the tag has changed within the predetermined time based on the information regarding the time.

6. The imaging apparatus according to claim 1, wherein the control unit is further configured to determine whether the subject is holding the tag.

7. The imaging apparatus according to claim 6, further comprising:
a rotational mechanism configured to rotationally drive a housing including an imaging lens and an image sensor in at least one or more axial direction; and
a zoom mechanism configured to perform zoom driving,
wherein the control unit is further configured to determine whether the subject is holding the tag based on a rotational angle of the rotational mechanism, a zoom magnification of the zoom mechanism, the position of the tag acquired, and the position of the acquired subject.

8. The imaging apparatus according to claim 6, wherein the control unit is further configured to:
calculate a motion vector of the position of the subject in a predetermined period, and
determine whether the subject is holding the tag based on a change amount of the position of the tag and the motion vector.

9. The imaging apparatus according to claim 6, wherein the control unit is further configured to set the position of the subject as the position of the main subject in a case where it is determined that the subject is holding the tag.

10. The imaging apparatus according to claim 6, wherein the control unit is further configured to set the position of the tag as the position of the main subject in a case where it is determined that the subject is not holding the tag.

11. The imaging apparatus according to claim 1, wherein the control unit is further configured to set the position of the subject as the position of the main subject in a case where the position of the tag has not been detected and the position of the subject has been identified.

12. The imaging apparatus according to claim 1, wherein the control unit is further configured to perform processing for searching for the subject in a case where the position of the tag has not been detected and the position of the subject has not been identified.

13. The imaging apparatus according to claim 1, wherein the control unit is further configured to track the main subject by rotationally driving a rotational mechanism.

14. The imaging apparatus according to claim 13, wherein the control unit is further configured to cause the imaging unit to operate based on tracking of the subject.

15. The imaging apparatus according to claim 1, wherein the subject is at least one of a person or an animal.

16. A method for controlling an imaging apparatus including an imaging unit, the method comprising:
identifying a position of a subject based on an image captured by the imaging unit;
detecting a position of a tag; and
switching, based on a change in the position of the tag, whether a position of a main subject is the identified position of the subject or the detected position of the tag.

17. A non-transitory computer readable medium that stores a program, the program causing a computer to execute a method for controlling an imaging apparatus including an imaging unit, the method comprising:
identifying a position of a subject based on an image captured by the imaging unit;
detecting a position of a tag; and
switching, based on a change in the acquired position of the tag, whether a position of a main subject is the identified position of the subject or the detected position of the tag.
